(19) United States
(12) Patent Application Publication
(10) Pub. No.: US 2020/0260223 A1
(43) Pub. Date: Aug. 13, 2020

(54) SYSTEM AND METHOD FOR OBJECT AND LOCATION-RELATED DELIVERY OF REAL-TIME MESSAGES

(71) Applicant: Spellbound Development Group, Inc., Irvine, CA (US)

(72) Inventors: Carlos David Reyes, Rancho Santa Margarita, CA (US); Earl Joseph Votolato, Newport Beach, CA (US)

(21) Appl. No.: 16/781,349

(22) Filed: Feb. 4, 2020

Related U.S. Application Data
(60) Provisional application No. 62/803,819, filed on Feb. 11, 2019.

(51) Int. Cl. H04W 4/029; H04W 68/00; H04W 88/06; H04L 12/58; H04L 29/08; H04W 64/00; H04W 4/021

(52) U.S. Cl. CPC H04W 4/029; H04W 68/005; H04W 88/06; H04W 4/021; H04L 67/04; H04W 64/003; H04L 51/04

(57) ABSTRACT

A system and method are described. In an example, the system includes a communication device that is associated with a user, one or more tags that are associated with objects and/or locations distributed throughout a physical space, and a messaging management server that is configured to generate and supply messages to the communication device of a user based on activity detected about the user with respect to the physical space.

### CROSS REFERENCE TO RELATED APPLICATIONS

This application claims priority to U.S. Provisional applications 62/803,819, filed on Feb. 11, 2019, the entire disclosure of which is hereby incorporated by reference.

### FIELD OF THE DISCLOSURE

Embodiments of the present disclosure relate to communication systems and, in particular, to systems that enable real-time delivery of messages to users based on location.

### BACKGROUND

Companies and other large organizations, in particular chain store operators with a young workforce (e.g. Taco Bell, Walmart, Kroeger, Target), generally have employees that require assistance and communications from management from time to time. For example, there are times when they need assistance on an emergency situation, how to operate some equipment, a safety matter, inventory support, or anything else that may come up where the employee needs real time assistance. In addition, there are times when a process should be monitored but the process may be one that it simply does not make sense for an employee to monitor the process by being present at the point of monitoring.

### SUMMARY

The need arises for a real-time communication system that an employee can activate at any time to give them immediate assistance without them having to leave their work station or location. In some embodiments, the system may be designed and configured to automatically alert and deliver a message to an employee of a certain out of specification or process window disruption on a predetermined process condition that may be taking place and that needs immediate action (e.g. equipment overheating, room temperature too high, baking oven not working at optimal temperature, temperature of food items shipped are not within safe temperature zone).

It is with respect to the above that embodiments of the present disclosure were contemplated. In particular, embodiments of the present disclosure contemplate an apparatus, device, system and method of real-time identification of objects, users, processes and locations and the distribution of specific information about, to and from those objects, end users and. locations via a plurality of components coupled together using wireless technology (e.g. Bluetooth® and Wi-Fi®).

Embodiments of the present disclosure make it possible to detect and identify specific objects, processes and or locations, and end users standing near or at those specific objects and or locations, and broadcasts audio, video and or text-based content related to that specific object, processes and or location, to those end users via a personal wearable, mobile device or location based device, to take some action.

Embodiments of the present disclosure provide a system to enhance any number of activities by providing and broadcasting real-time information to one or more end users that may require immediate assistance and access to the information. The contemplated activities may include workplace employee training, support, reminders, notifications, equipment operating instruction, safety and caution messaging, directions, procedures, process controls and monitoring, and emergency response assistance. Embodiments of the present disclosure may also be used for the general consumer visiting public displays and exhibits found in museums, resorts, parks, etc.

Embodiments of the present disclosure may include a user communication device (e.g., a smart wireless device that each end user has in their possession). The device may be configured to store and transmit end user data. In addition, the device may be configured to receive and plays back broadcasted audio, video and or text-based content. This component could also be a locally fixed in place device (e.g. monitor, audio system) that is located at or a tag. Embodiments of the present disclosure also contemplate a tag device that may include any number of wireless components for identifying the end user associated with a user communication device, their data, location, a process and or object properties (e.g., facial recognition, RFID, sensors for process controls, etc.).

Embodiments of the present disclosure also contemplate a storage component that stores end user data, location, process control and object data, and audio and or video content, either coupled to the tag (e.g., wired or wirelessly).

Embodiments of the present disclosure also contemplate a message management server, which may operate as a host controller. The message management server may be coupled to the various communication devices, tags, and storage components and, in some embodiments, may be configured to process and manage, through firmware and a software stack, the distribution of all end users' location and object, process control data to and or between each end user's wearable and or mobile component, location and object identification component, and components that stores all end users data, location and object data, and audio and or video content. It also manages the broadcasting of audio, text and or video content to each end user's wearable and or mobile component. Each component of the system is contemplated to be coupled together (e.g., via a wired and/or wireless connection) and interact and communicate with one or more of the other components in the system.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity may refer to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The present disclosure is described in conjunction with the appended figures, which are not necessarily drawn to scale:

FIG. 1 is a block diagram depicting a system in accordance with at least some embodiments of the present disclosure;

FIG. 2 is a block diagram depicting a communication system in accordance with at least some embodiments of the present disclosure;

FIG. 3 is a diagram depicting a physical space in accordance with at least some embodiments of the present disclosure;

FIG. 4 is a block diagram depicting details of a communication device in accordance with at least some embodiments of the present disclosure;

FIG. 5 is a block diagram depicting details of a tag in accordance with at least some embodiments of the present disclosure;

FIG. 6 is a flow diagram depicting a first messaging method in accordance with at least some embodiments of the present disclosure;

FIG. 7 is a flow diagram depicting a second messaging method in accordance with at least some embodiments of the present disclosure;

FIG. 8 is a flow diagram depicting a third messaging method in accordance with at least some embodiments of the present disclosure;

FIG. 9 is a flow diagram depicting a fourth messaging method in accordance with at least some embodiments of the present disclosure; and

FIG. 10 is a flow diagram depicting a fifth messaging method in accordance with at least some embodiments of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

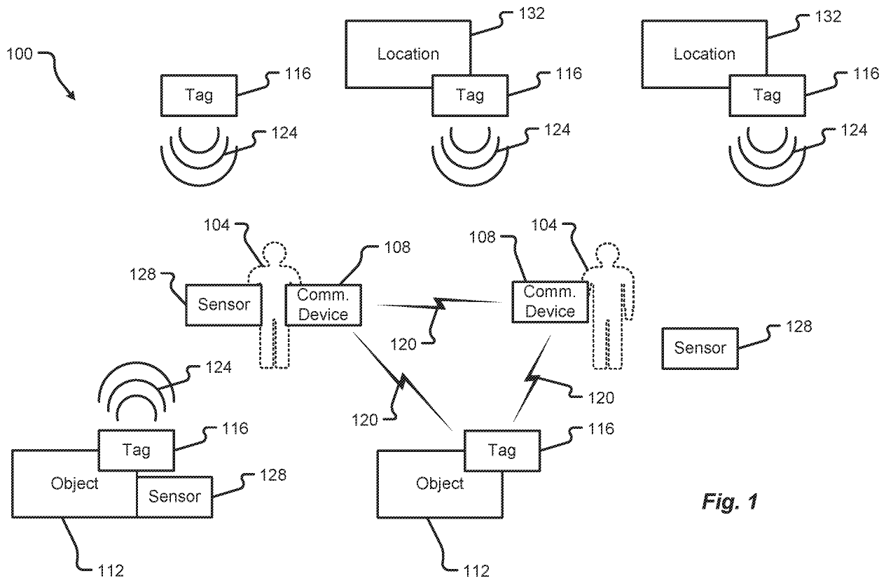

With reference initially to FIG. 1, a system 100 will now be described in accordance with at least some embodiments of the present disclosure. The system 100 is shown to include a number of electronic devices distributed throughout a physical space, some of which may be associated with particular predetermined locations 132, some of which may be associated with particular predetermined objects 112, and some of which may be associated with particular users 104 that are allowed to travel through the physical space. More specifically, the system 100 is shown to include one or many communication devices 108 that may be associated with a particular user 104 or with a number of users 104. The system is also shown to include one or many tags 116 that may be associated with a particular object 112 or location 132. In some embodiments, the communication devices 108 may be configured to communicate with one another, either directly via a communication link 120 or indirectly via a communication network that provides connectivity between the communication devices 108. Furthermore, the tags 116 may be configured to communicate with the communication devices 108 either directly via a communication link 120 or indirectly via a communication network.

As shown in FIG. 1, a communication device 108 may be associated with a particular user 104. In some embodiments, the communication device 108 may correspond to a wearable communication device such as a personal headset. In some embodiments, the communication device 108 may correspond to a portable smartphone or the like. In some embodiments, the communication device 108 may correspond to a wearable device such as watch, bracelet, garment configured with a microphone and speaker, etc.

As the user 104 moves throughout the physical space the communication device 108 may move into and out of proximity with particular tags 116. In some embodiments, the physical proximity of the communication device 108 with a particular tag 116 may cause the communication device 108 and tag 116 to pair with one another and establish the communication link 120. This communication link 120 may be facilitated by a proximity-based communication protocol, such as Bluetooth®, WiFi, Zigbee, NFC, or the like. Information from the tag 116 may be communicated to the communication device 108 via the communication link 120 and information about the communication device 108 (and the associated user 104) may be communicated to the tag 116 via the communication link 120. Thus, because the establishment of the communication link 120 is predicated upon communication device 108 being within a predetermined distance of the tag 116, it can be assumed that when the communication link 120 is established, the user 104 is within a predetermined distance of an object 112 or location 132 associated with the tag 116.

When a communication device 108 is not within a predetermined distance of a tag 116, the tag 116 may still be configured to emit or broadcast information about itself or about an object 112 or location 132 associated with the tag 116. In some embodiments, the tag 116 may be configured to generate a broadcast signal 124 that is actively emitted by an RF field. This broadcast signal may include data stored locally in memory of the tag 116. For instance, each tag 116 may be configured to actively, and without request from another communication device 108, broadcast its identification information via the broadcast signal 124. Alternatively or additionally, each tag 116 may be configured to broadcast information describing an associate object 112 or associated location 132 via the broadcast signal 124. This broadcast information may or may not correspond to all descriptive information for the tag 116, object 112, and/or location 132. In some embodiments, the broadcast information may be sufficient to enable the communication device 108 to pair with the tag 116 and then establish the communication link 120. The communication link 120 may then be used to communicate more detailed information about the tag 116, object 112, or location 132 to the communication device 108. In other embodiments, the tag 116 may communicate information to the communication device 108 that enables the communication device 108 to send a request for detailed information to a message management server, which may respond to the request with the detailed information.

As can be seen in FIG. 1, the system 100 may also include one or more sensors 128 that are distributed throughout the physical space. Some sensors 128 may be used to detect a position of the user 104 and/or communication device 108 within the physical space. Some sensors 128 may be associated with a particular object 112 or location 132 and may be used to monitor physical properties of the object 112. Such physical properties may be stored in memory of the tag 116 or may be communicated to a remote messaging management server for later reference by a communication device 108. Thus, in some embodiments, the information from the sensor 128 may be communicated via the broadcast signal 124 or via some other communication method to a centralized repository for sensor information. The communication device 108, when brought within a predetermined proximity of a tag 116, may be configured to request information for an object 112/sensor 128 pair from the centralized repository for sensor information. The communication device 108 may then be configured to provide a message (e.g., audio, video, text, etc.) to a user 104 of the communication device 108 that describes the condition of the sensor 128, the condition of the object 112, and possibly a state of the object 112. It should be appreciated that, in some embodiments, the tag 116 and sensor 128 may be integrated into a single device and may be fixed or physically positioned near an object 112 to enable the sensor 128 to monitor a physical aspect of the object 112. Some sensors 128 may be provided on or near a user, on an article or device worn by a user, or the like. A sensor 128 positioned in proximity with a user in this manner may be able to provide sensor information describing one or more conditions about the user including, without limitation, walking speed, altitude, user acceleration, heart rate, blood pressure, temperature, blood oxygen levels, or any other characteristic of the user.

A sensor 128 may include any type of known physical transceiver device that is configured to convert a sensed physical property into an electrical signal. Non-limiting examples of a sensor 128 include a temperature sensor, a humidity sensor, a vibration sensor, an accelerometer, a strain sensor, a motion sensor, a flow sensor, etc. It should be appreciated that a sensor 128 may be configured to sense one or many physical properties of an object 112 without departing from the scope of the present disclosure. As will be appreciated the information sensed by the senor 128 may be stored locally in memory of the tag 116 or in a centralized repository for sensor information. In the latter situation, the sensor 128 (or a communication device paired with the sensor 128) may be configured to transmit the sensor information to the centralized repository for sensor information intermittently, periodically, or as a data stream in real-time or near-real-time.

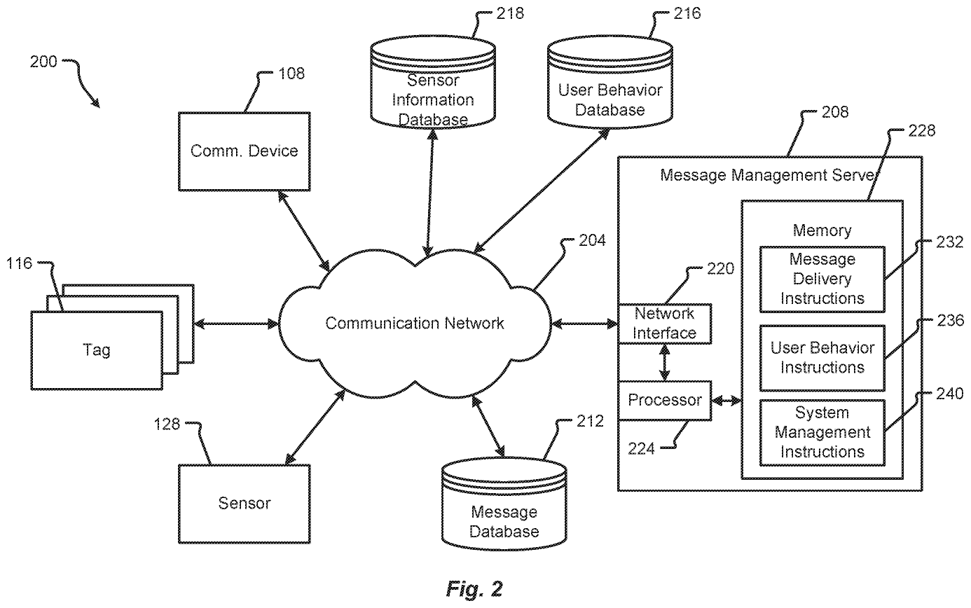

With reference now to FIG. 2, additional details of a communication system 200 that can be used to manage the distribution and sharing of messages between communication devices 108 and between tags 116 and sensors 128 will be described in accordance with at least some embodiments of the present disclosure. The system 200 is shown to include a plurality of tags 116 that are in communication with a message management server 208 via a communication network 204. In some embodiments, one or more tags 116 may be configured to share information from a sensor 128 back to the message management server 208, where the message management server 208 corresponds to a centralized repository for sensor information. Alternatively or additionally, the tags 116 may share sensor information with a communication device 108, via a communication link 120, and then the communication device 108 may be configured to transmit the sensor information back to the message management server 208 for storage and later reference in connection with delivering messages back to a communication device 108 and user 104. The information collected from various sensors 128 may be stored by the message management sever 208 in a sensor information database 218.

The message management server 208 may also utilize a message database 212 and/or user behavior database 216 to determine timing and content of messages for delivery to a user 104 via their communication device 108. In particular, the communication system 200 and message management server 208 of the communication system 200 may be configured to receive information about a location of a communication device 108 within the physical space (e.g., based on information obtained from sensors 128 and/or tags 116). This location information for a communication device 108 may enable the message management server 208 to identify one or more messages from the message database 212 for delivery to the communication device 108. In some embodiments, the messages stored in the message database 212 may include references to sensor information stored in the sensor information database 218. Furthermore, the timing of delivery of a message to a user 104 may depend upon rules stored in the message management server 208 as well as user behavior models stored in the user behavior database 216. In some embodiments, each user 104 may have a different role within the physical space (e.g., manager, supervisor, line cook, head chef, waiter, drive-thru attendant, etc.) and this role may define different times and/or conditions when a message should be transmitted to the user 104.

Furthermore, each user 104 may have a personalized user behavior model stored in the user behavior database 216. The message management server 208 may be configured to update and manage such personalized user behavior models. Furthermore, the message management server 208 may be configured to refer to the personalized user behavior models to determine when a message should be delivered to a user 104 in addition to determining a content for the message to be delivered to a user 104. As used herein, a user's behavior or any related information stored within the user behavior database 216 may include information describing pre-approved limits a user has relative to equipment, an object 112, locations 132, etc. More specifically, a user's permitted behavior may be stored in the user behavior database 216 as a list of objects the user 104 is allowed to operate. Alternatively or additionally, permitted or non-permitted paths of travel for a user 104 may be defined within the user behavior database 216. Additional types of information that may be stored in the user behavior database 216 include, without limitation, user language preferences, user characteristics, user roles, user employment history, user path of travel history, expected user path of travel, expected objects 112 that a user 104 should engage as part of their job description, predetermined check-points the user 104 should pass as part of their job duties, etc. Thus, the creation or population of messages by the message management server 208 may depend upon a number of parameters that are stored and maintained in the user behavior database 216. In some embodiments, the messages may be user-specific, role-specific, dependent upon a condition of an object 112 as determined by information from the sensor information database 218, etc.

The communication system 200 is also shown to include a communication network 204 that provides machine-to-machine communication capabilities. The various components of the communication system 200 may be in wired and/or wireless communication via the communication network 204. In some embodiments, the communication devices 108 may correspond to any type of portable device (e.g., wearable device, portable smartphone, portable tablet, headset, etc.), but such a configuration is not required. Rather, a communication device 108 may also include a Personal Computer (PC), Point of Service (POS) device, or the like.

The message management server 208 may correspond to one or many servers that are used to manage the distribution of messages throughout the communication system 200. In some embodiments, the message management server 208 may include a network interface 220, a processor 224, and memory 228. The memory 228 may be configured to stored executable instruction sets that enable functionality of the server 208. Non-limiting examples of the instruction sets include a message delivery instruction set 232, a user behavior instruction set 236, and a system management instruction set 240. Each of the instruction sets may be executable by the processor 224.

The message delivery instruction set 232 may be configured to utilize the message database 212 to determine a content of message(s) for delivery to a user's 104 communication device 108. In some embodiments, the content of the message(s) that are delivered to a communication device 108 may depend upon a location of the communication device 108 within the physical space (e.g., as determined by a communication device's 108 position relative to a tag 116, relative to other communication devices 108, relative to an object 112, relative to a location 132, as measured by a sensor 128, etc.). Alternatively or additionally, the content of message(s) delivered to a communication device 108 may depend upon a communication link 120 established at the communication device 108 and information shared over the communication link 120. For example, a tag 116 may be configured to share information over the communication link 120 with the communication device 108 and that information may then be provided to the message management server 208. The message management server 208 may utilize the message delivery instruction set 232 to analyze the content of the message received from the communication device 108 (e.g., an identification of a tag 116, sensor information, etc.) and then reference that content against one or more predetermined messages in the message database 212. The message delivery instruction set 232 may then be configured to generate and provide one or more messages back to the communication device 108 for delivery to the user 104 of the communication device 108.

The user behavior instruction set 236, when executed by the processor 224, may enable the message management server 208 to reference user behavior models stored in the user behavior database 216. Alternatively or additionally, the user behavior instruction set 236 may be configured to enable the message management server 208 to update user behavior models stored in the database 216. Alternatively or additionally, the user behavior instruction set 236 may be configured to determine when a particular user's 104 behavior is within a normal behavior as defined by a user behavior model or outside a normal behavior. Depending upon whether or not the user's 104 behavior is within or not within a defined normal, the message management server 208 may be configured to generate and send a message to the user's 104 communication device 108.

The system management instruction set 240, when executed by the processor 224, may enable the message management server 208 to manage and maintain sensor information in the sensor information database 218. The system management instruction set 240 may also be configured to receive information from the various sensors 128 and store the information in the sensor information database 218. Alternatively or additionally, the system management instruction set 240 may be configured to determine when sensor-related information should be included in a message from the message database and provided to a user's 104 communication device 108. In some embodiments, sensor information from the sensor information database 218 may be included in a message transmitted to a user's communication device 108 when the user's communication device 108 is within a predetermined proximity of an object 112 being monitored by a sensor 128. Alternatively or additionally, if an emergency condition is detected by the system management instruction set 240, then the message management server 208 may be configured to transmit or broadcast an emergency message to all communication devices 108 indicating a nature of the emergency condition and instructions for resolving the emergency condition. Of course, the system management instruction set 240 may work in cooperation with the message delivery instruction set 232 to determine a content of the message to transmit to the user's 104 communication devices 108 and whether such message(s) should include sensor information, object information, location information, etc.

The instruction sets of the server 208 may enable functionality of the server 208 and/or system 100, 200 as will be described herein. In some embodiments, the memory 228 may correspond to a computer-readable storage medium that is configured to store a number of processor-executable instruction sets. In addition to storing traditional computer programs or discrete instruction sets that receive an input and variables and provide an output based on the input and variables, the memory 228 may also be used to store one or more Artificial Intelligence (AI) programs that are configured to receive inputs and process the inputs through one or more neural networks. The AI program(s) stored in memory 228 may also be configured to be trained or otherwise updated in an autonomous or semi-autonomous manner.

In some embodiments, the databases 212, 216, 218 may be hierarchical databases, SQL databases, NoSQL databases, graphical databases, or any other type of database known in the art. The information stored in the various databases 212, 216, 218 may be configured to be stored within the message management server 208 rather than being stored in a separate database.

The communication network 204 may correspond to any known type of network that facilitates machine-to-machine communications as noted above. The network 204 may use the same communication protocols or different protocols without departing from the scope of the present disclosure. In some embodiments, the devices connected with the network 204 may be configured to communicate using various nodes or components of the communication network 204. The communication network 204 may correspond to one or many different networks, and may also comprise any type of known communication medium or collection of communication media and may use any type of protocols to transport messages between endpoints. The network 204 may include wired and/or wireless communication technologies. The Internet is an example of a communication network that constitutes an Internet Protocol (IP) network consisting of many computers, computing networks, and other communication devices located all over the world, which are connected through many telephone systems and other means. Other examples of a communication network include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over Internet Protocol (VoIP) network, an ad-hoc communication network, a cellular network, and any other type of packet-switched or circuit-switched network known in the art. In addition, it can be appreciated that the communication network 204 need not be limited to any one network type, and instead may be comprised of a number of different networks and/or network types. Moreover, the communication network 204 may include a number of different communication media such as coaxial cable, copper cable/wire, fiber-optic cable, antennas for transmitting/receiving wireless messages, and combinations thereof

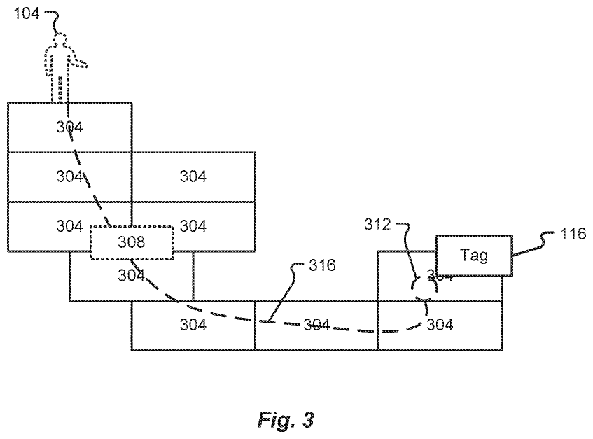

With reference now to FIG. 3, additional details of a physical space and a user's 104 motion throughout the space will be described in accordance with at least some embodiments of the present disclosure. The physical space is shown to include a number of adjacent areas 304 through which the user 104 is capable of travelling. Each of the areas 304 may correspond to a physical area and may be discernable based on a distribution of tags 116 and/or sensors 128 throughout the physical space. That is to say, a user 104 motion through the physical spaces and the areas 304 of the physical space may be detected by tags 116, sensors 128, or by information received from a communication device 108 of the user 104.

FIG. 3 shows the user 104 travelling a path 316 through the various adjacent areas 304. The user's 104 path is shown to travel through a predetermined waypoint 308 and end at a particular end location 312. The end location 312 of the user's 104 path 316 may be detected based on the user's 104 communication device 108 establishing a communication link 120 with a particular tag 116. As will be discussed in further detail herein, if the user 104 is detected as having travelled the path 316 and passing the waypoint 308, then arriving at the end location 312, the user 104 may be provided with a predetermined message from the message management server 208. For instance, if the waypoint 308 corresponds to a corridor or door within a physical building and the end location 312 corresponds to a restroom, then the user 104 may be provided with a predetermined message that reminds the user 104 to wash their hands prior to leaving the area 304 in which the tag 116 is located and in which the end location 312 is positioned. It should be appreciated that delivery of a predetermined message to the user 104 may depend upon the user 104 traversing a predetermined path 316. Such a path of travel may or may not be within a normal or expected user behavior as defined by a user behavior model stored in the user behavior database 216.

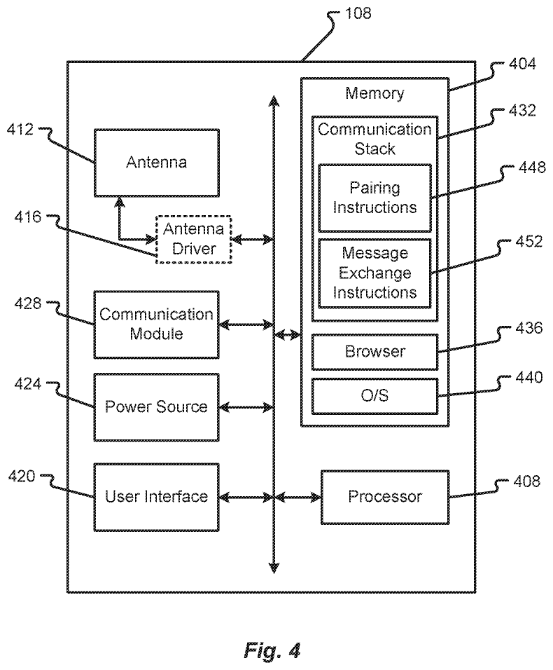

With reference now to FIG. 4, additional details of a communication device 108 will be described in accordance with at least some embodiments of the present disclosure. The communication device 108 is shown to include one or more components, such as, a memory 404, a processor 408, an antenna 412, a user interface 420, a communication module 428, and a user interface 420. In some embodiments, the communication device 108 may further include a power source 424, such as a battery and one or more conversion circuits suitable to convert external power into useable power for components of the communication device 108.

The memory 404 of the communication device 108 may be used in connection with the execution of application programming or instructions by the processor 408, and for the temporary or long-term storage of program instructions and/or data. The memory 404 may contain executable instructions that are used by the processor 408 to run other components of the communication device 108. In one embodiment, the memory 404 may be configured to store some or all information that enables communication with other components of the communication system 200. For instance, the memory 404 may be configured to store a communication stack 432 that includes a pairing instruction set 448 and a message exchange instruction set 452. The pairing instruction set 448, when executed by the processor 408, may enable the communication device 108 to pair with a tag 116 or other communication device 108. For instance, the pairing instruction set 448 may include a Bluetooth, Wifi, and/or Zigbee pairing instruction set. Alternatively or additionally, the pairing instruction set 448 may include instructions that enable the communication device 108 to connect with the communication network 204.

The message exchange instruction set 452, when executed by the processor 408, may enable the communication device 108 to exchange information with a tag 116, another communication device 108, or with any other device of the communication system 200. In some embodiments, the message exchange instruction set 452 may enable the communication device to exchange information with a messaging management server 208 and present messages received from a tag 116 or server 208 via the user interface 420. For instance, audible, video, and/or text-based messages may be presented to the user 104 via the user interface 420.

Various applications or routines provided on the communication device 108 may be viewable or made available through an operating system O/S 440 of the communication device 108. In addition to an O/S 440, the communication device 108 may also include one or more browsers 436. A browser 436 represents another type of application that is stored in memory 404 that enables communication at the application-layer via the communication network 204. The browser 436 may enable the communication device 108 to communicate with the messaging management server 208. In some embodiments, the browser 436 may be configured to reference a URL or address received from a tag 116 and resolve the URL or address at the message management server 208. When the communication device 108 resolves to the URL or address received from the tag 116, the message management server 208 may provide a predetermined message back to the communication device 108. In some embodiments, the content of the message provided back to the communication device 108 in response to receiving the request from the communication device 108 (e.g., an HTTP or HTTPS GET request) may be customized or modified to include sensor information from the sensor information database 218. Alternatively or additionally, the message provided back to the communication device 108 by the server 208 may be customized or modified based upon a path 316 travelled by the user 104 and a determination of whether such path 316 travelled through a waypoint 308, completed at a predetermined location 312, and/or was within a defined normal or expected path of travel for the user 104. Illustrative but non-limiting examples of a browser 436 include (e.g., Safari, Firefox, Chrome, Microsoft Edge, Opera, Vivaldi, or the like). Instructions that enable the communication device 108 to communicate via the communication links 120 may include Bluetooth instructions, NFC instructions, WiFi instructions, etc. In some embodiments, the memory 404 may comprise volatile or non-volatile memory. Non-limiting examples of memory 404 that may be utilized in the mobile communication device 104 include RAM, ROM, buffer memory, flash memory, solid-state memory, or variants thereof.

The processor 408 may correspond to one or many microprocessors that are contained within the housing of the communication device 108 with the memory 404. In some embodiments, the processor 408 incorporates the functions of the user device's Central Processing Unit (CPU) on a single Integrated Circuit (IC) or a few IC chips. The processor 408 may be a multipurpose, programmable device that accepts digital data as input, processes the digital data according to instructions stored in its internal memory, and provides results as output. The processor 408 implements sequential digital logic as it has internal memory. As with most known microprocessors, the processor 408 may operate on numbers and symbols represented in the binary numeral system.

The antenna 412 may correspond to one or multiple antennas and, in some embodiments, may be configured to enable wireless communications between the communication device 108 and a tag 116. As can be appreciated, the antenna(s) 412 may be arranged to operate using one or more wireless communication protocols and operating frequencies including, but not limited to, Bluetooth®, BLE, NFC, ZigBee, GSM, CDMA, Wi-Fi, RF, and the like. By way of example, the antenna(s) 412 may be RF antenna(s), and as such, may transmit RF signals through free-space to be received by tag 116 having an RF transceiver. One or more of the antennas 412 may be driven or operated by a dedicated antenna driver 416.

As mentioned above, the communication device 108 may include a power source 424. The power source 424 may be configured to provide power to the parts of the communication device 108 for operational purposes. The power source 424 may store power in a capacitor or similar type of charge-storage device. In one embodiment, electronics in the power source 424 may store energy in the capacitor and turn off when an RF field is present. This arrangement can ensure that energy is presented to the communication device 108 minimizing any effect on read distance. For example, the power source 424 may include a battery or other power source to supply power to parts of the communication device 108. The power source 424 may include a built-in power supply (e.g., battery) and/or a power converter that facilitates the conversion of externally-supplied AC power into DC power that is used to power the various components of the mobile device 128, 208. In some embodiments, the power source 424 may also include some implementation of surge protection circuitry to protect the components of the device 108 from power surges.

The communication device 108 may include a communication module 428 that is configured to communicate with one or more different systems or devices either remote or local to the communication device 108. Thus, the communication module 428 can send or receive messages to or from the server 208. In some embodiments, the communications module 428 or functionality thereof may be included in the communication stack 432.

The user interface 420 may or may not include one or more input devices and/or display devices. Examples of suitable user input devices that may be included in the user interface 420 include, without limitation, buttons, keyboards, mouse, touch-sensitive surfaces, pen, camera, microphone, body-worn sensors, heart rate monitors, body position monitors, blood oxygen monitors, hydration monitors, body temperature monitors, altimeters, etc. Examples of suitable user output devices that may be included in the user interface 420 include, without limitation, display screens, touchscreens, lights, speakers, etc. It should be appreciated that the user interface 420 may also include a combined user input and user output device, such as a touch-sensitive display or the like.

A network interface may also be provided that comprises hardware to facilitate communications with other communication devices over the communication network 204. The network interface may include an Ethernet port, a Wi-Fi card, a Network Interface Card (NIC), a cellular interface (e.g., antenna, filters, and associated circuitry), or the like. The network interface, in some embodiments, may correspond to a combination of the communication module 428 and an antenna 412 and may be configured to facilitate a connection between the communication device 108 and the communication network 204 and may further be configured to encode and decode communications (e.g., packets) according to a protocol utilized by the communication network 204.

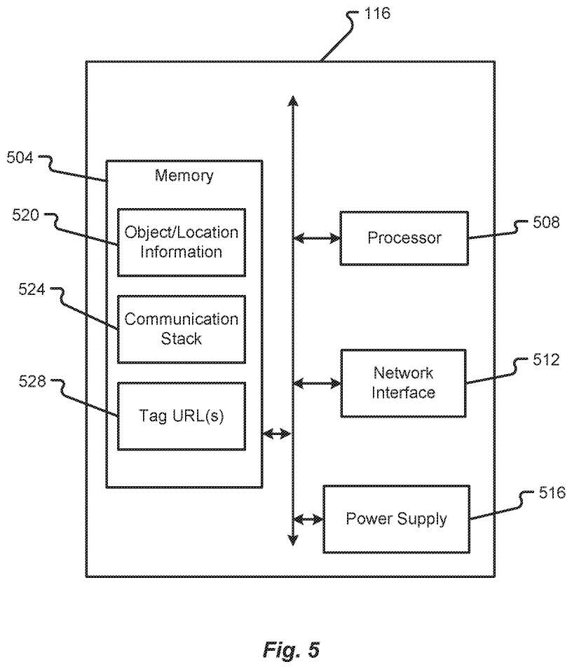

With reference now to FIG. 5, additional details of a tag 116 will be described in accordance with at least some embodiments of the present disclosure. A tag 116 is shown to include memory 504, a processor 508, one or more network interfaces 512, and a power supply 516.

The memory 504, in some embodiments, may include any type of computer memory device or collection of computer memory devices. Non-limiting examples of memory 504 include Random Access Memory (RAM), Read Only Memory (ROM), flash memory, Electronically-Erasable Programmable ROM (EEPROM), Dynamic RAM (DRAM), etc. The memory 504 may be configured to operate using a relatively small amount of power from the power supply 516. In some embodiments, the tag 116 may correspond to a low-power Bluetooth tag that is configured to operate its communication stack 524 at only predetermined intervals or time. Otherwise, the processing resources of the tag 116 are reserved, thereby limiting an amount of power consumed from the power supply 516. This may be particularly useful if the power supply 516 corresponds to a self-contained power supply, such as a battery.

The information stored in memory 504 may include object/location information 520. This information may correspond to data that is programmed into memory 504 when the tag 116 is physically associated with an object 112 or location 132. This information may include an actual description of an object 112 or location 132. Alternatively or additionally, the object/location information 520 may correspond to an identifier or reference to a unique value that represents the object 112 or location 132 within the messaging database 212. The memory 504 is also shown to store one or more tag URLs 528. In some embodiments, the tag URL(s) 528 may include the object/location information 520. For instance, the tag URLs 528 may be encoded with information that allows the browser of the communication device 108 to resolve to a particular website at the server 208 and that particular website may be uniquely associated with the object 112 or location 132 based on the object/location information 520 or, more specifically, the information contained in the tag URL(s) 528.

The communication stack 524 may be similar or identical to the communication stack 432 of the communication device 108. In some embodiments, the communication stack 432 is configured to enable the tag 116 to establish a communication link 120 (e.g., via a pairing process), communicate via a communication link 120, and/or broadcast information via the broadcast signal 124. The communication stack 524 may enable communications via any type of known or yet to be developed communication protocol such as Bluetooth, WiFi, Zigbee, NFC, etc.

The processor 508 may correspond to one or many computer processing devices. For instance, the processor 508 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 508 may be provided as a microprocessor, Central Processing Unit (CPU), or plurality of microprocessors or CPUs that are configured to execute the instructions sets stored in memory 504. Upon executing the instruction sets stored in memory 504, the processor 508 enables functionality of the tag 116.

The network interface(s) 512 may include an antenna or the like that enables the broadcasting or establishment of the communication link 120. In some embodiments, the network interface(s) 512 may correspond to a simple low-power antenna that is configured to transmit and receive information in accordance with the communication stack 524.

The power supply 516 may correspond to an integrated power supply device (e.g., a battery) and/or a power conversion device that is configured to convert external AC power into useable power for the various components of the tag 116. In some embodiments, the power supply device 516 may include one or more devices that are capable of conditioning external power into DC current with a stepped voltage that can be used by the memory 504, processor 508, and network interface(s) 512.

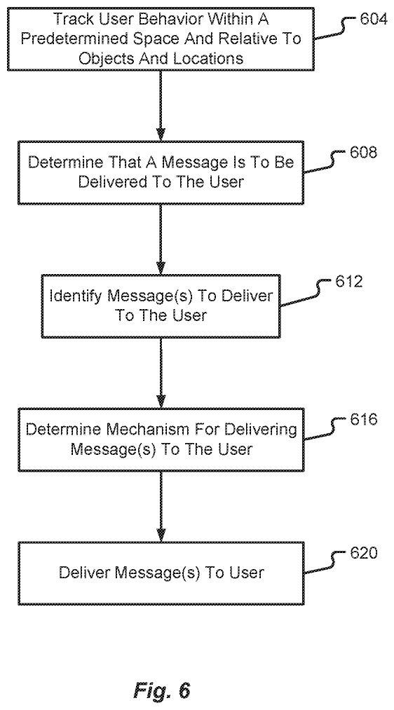

With reference now to FIG. 6, a first messaging method will be described in accordance with at least some embodiments of the present disclosure. The method begins with the message management server 208 tracking a user 104 behavior within a predetermined space and relative to objects 112 and locations 132 (step 604). The server 208 may be configured to track such user 104 activity with information received from sensors 128 in addition to using information received from a user's 104 communication device 108 as they travel through a plurality of adjacent areas 304. For instance, the communication device 108 may be configured to self-report location information to the server 208 or at least provide information received from various tags 116 that help describe a position and movement of the communication device 116 relative to the distributed tags 116 and, therefore, relative to the adjacent areas 304.

The method continues by determining, based on the tracked user behavior, that a message is to be delivered to the user 104 (step 608). This determination may be made by the server 208 based on the location of the user 104, a location of the user's 104 communication device 108, a path 316 travelled by the user 104, a waypoint 308 passed by the user 104, an end location 312 of the user 104, a communication link 120 established by the communication device 108, or combinations thereof. The server 208 may make the determination that a message is to be provided to the user 104 based on information obtained from the sensors 128 in addition to making the determination based on the tracked user behavior.

The server 208 continues by identifying a message or plurality of messages to provide to the user 104 (step 612). In this step the server 208 may also identify content of the message(s) to provide to the user 104. In some embodiments, the server 208 may be configured to determine a content of the message(s) based on information received from the communication device 108 of the user 104 and/or based on information received from other components of the system 100. For example, the content of the message to be provided to the user 104 may be dependent upon conditions of an object 112 monitored by a sensor 128. The content of the message provided to the user 104 may also depend upon the monitored user behavior, user location, user path 316, etc.

The method then continues with the server 208 determining a mechanism for delivering the message(s) to the user 104 (step 616). The message delivery mechanism may be determined by the message delivery instruction set 232 and may depend upon the nature of the message, the communication capabilities of the communication device 108, and other considerations. In some embodiments, the message delivery mechanism may include delivery of the message at the user's 104 communication device 108 or via a tag 116.

The method continues with the server 208 delivering the message(s) to the user 104 (step 620). In some embodiments, the message(s) are delivered to the user's 104 communication device 108 via the communication network 204 or via a communication link 120. Alternatively or additionally, embodiments of the present disclosure contemplate delivering the message(s) to one or more other users (e.g., users in the system that are different from user 104). The one or more other users that receive the message(s) may have similar or different profiles from user 104. In some embodiments, when a predetermined condition (or set of conditions) is met by the user 104 (e.g., the user 104 enters and unauthorized area or is, for an extended period of time, in proximity of an object or piece of equipment that the user 104 is not authorized to use), then one or more other users (e.g., a supervisor user) may receive a message. Thus, in accordance with embodiments of the present disclosure, activities or conditions related to user 104 may be used to trigger message delivery to a different user.

It should be noted that any of the messaging methods depicted and described herein are not limited to the delivery of a particular message to a particular user based solely on activities, conditions, behaviors, or actions of that user. Rather, embodiments of the present disclosure contemplate conditioning message delivery to one or more users based on activities, conditions, behaviors, or actions of other users or groups of users. Furthermore, a message of a first type being delivered to a first user may cause a message of a second type to be generated and delivered to a second user, where the first type is different from the second type and the first user is different from the second user.

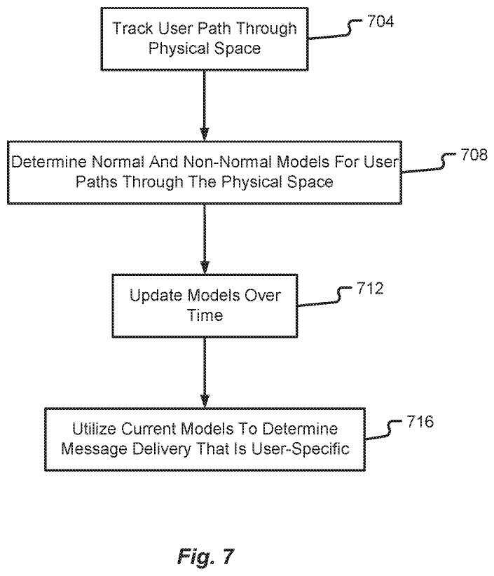

With reference now to FIG. 7, a second messaging method will be described in accordance with at least some embodiments of the present disclosure. The method begins with the server 208 tracking a user path 316 through a physical space (step 704). The user's 104 path 316 through the physical space may be tracked with reference to location information received from the user's communication device 108, with information received from sensors 128, and/or with information received from tags 116.

The server 208 may then utilize the user behavior instruction set 236 to determine a normal and/or non-normal model for user paths through the physical space (step 708). In some embodiments, the user models may be determined and maintained on a per-user basis. In some embodiments, the user models may be determined for a population of users and may only be updated when large variances from the models are detected. In some embodiments, the definition of normal and non-normal paths through the physical space may depend upon a user's 104 role in the space, a user's previous path history, responsibilities of the user 104, a previous path travelled by the user 104, etc.

As the server 208 observes and tracks user path activity through the physical space over time, the server 208 may utilize the user behavior instruction set 236 to update the normal and/or non-normal models in the user behavior database 216 over time (step 712). The models in the user behavior database 216 may be utilized by the user behavior instruction set 236 to determine message delivery or message content that is user-specific (step 716). Not only may the message delivery and content be user-specific and dependent upon the defined normal and non-normal models, but message delivery and message content may depend upon a combination of the normal and non-normal models along with current environmental conditions (e.g., as determined by information stored in the sensor information database 218). Additionally, the message delivery may be targeted toward a user whose behavior/path activity was not being tracked. For example, behaviors and/or path activity of the user 104 may result in a message being delivered to a different user and the message content may be specific to the user that receives the message, specific to the user 104 being tracked, or specific to the combination of the user receiving the message and the user 104 being tracked.

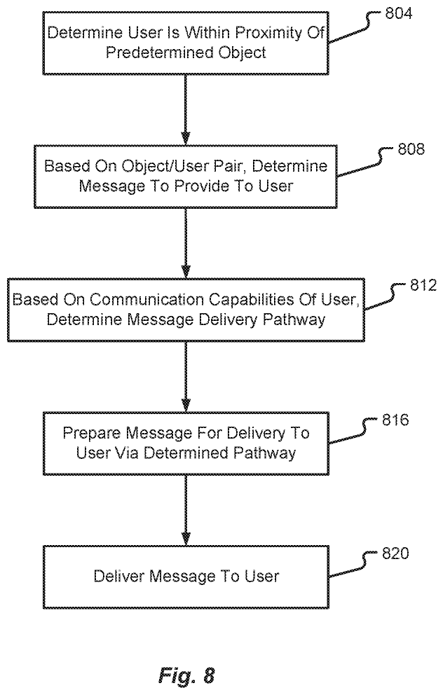

With reference now to FIG. 8, a third messaging method will be described in accordance with at least some embodiments of the present disclosure. The method begins by determining that a user 104 is within proximity of a predetermined object 112 (step 804). This determination may be made in response to determining that the user's 104 communication device 108 has established a communication link 120 with a tag 116 that is associated or otherwise affixed to/near the predetermined object 112.

In response to determining that the user 104 is within a proximity of the predetermined object 112 and based on an object/user pair, the server 208 may determine a message to provide to the user 104 (step 808). In some embodiments, an object/user pair may be determined in response to a communication device 108 associated with a particular user 104 pairing and establishing a communication link 120 with a tag 116 associated with a particular object 112. When such a pairing is established between a communication device 108 and tag 116, an object/user pairing may be inferred, meaning that the particular user 104 is within a predetermined proximity of the particular object 112. When an object/user pairing is determined, the object/user pairing may be used to reference the message database 212 and determine whether a particular and predetermined message should be generated for the user 104 based on the object/user pair. In other words, a first user 104 may receive a first message (as defined by a message contained in the message database 212) when the first user 104 is within a predetermined proximity of a particular object whereas a second user 104 may receive a second, different, message (as defined by a message contained in the message database 212) when the second user 104 is within a predetermined proximity of the same particular object. For instance, a first user 104 detected within proximity of a predetermined object 112 (e.g., a stove) may be provided with a first message that depends upon the object/user pair and, in particular, a role of the first user 104. This first message, as a non-limiting example, may correspond to a reminder to check the stove for a food item being cooked and may specifically be provided to the first user if the first user has a known role of chef or the like. On the other hand, if a second user 104 is detected within proximity of the same predetermined object 112, but the second user 104 has a different role than the first user 104, then the message provided to the second user 104 may be different than the first message. For instance, the second message may correspond to a reminder to avoid the stove as a hot surface or to obtain help from another employee with a different role.

Based on the communication capabilities of the user 104 and the object/user pair, the server 208 determines a message delivery pathway or mechanism (step 812). The message delivery instruction set 232 is then used to prepare the appropriate message(s) for delivery via the determined pathway (step 816) and then the message(s) is delivered to the user 104 (step 820). In some embodiments, the message(s) may be delivered by the communication link 120, by the communication network 204, or a combination of the two. In some embodiments, if multiple messages are provided to the user, then the messages may or may not be delivered by the same communication pathway. For instance, one message may be delivered via the communication link 120 whereas another message may be delivered via the communication network 204.

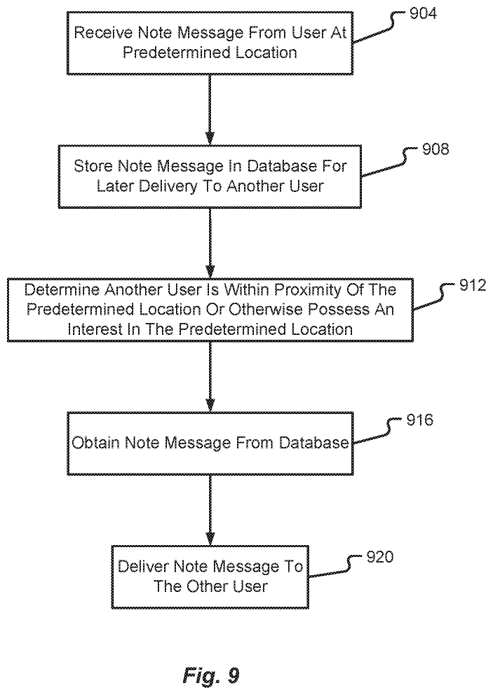

With reference now to FIG. 9, a fourth messaging method will be described in accordance with at least some embodiments of the present disclosure. The method begins by receiving a note from a user 104 at a predetermined location 132 (step 904). The note may correspond to an audio, video, or text-based note. The note may be composed by the user 104 or may be selected from among a plurality of canned and predetermined notes. As a non-limiting example, the note may include a note related to an object 112 at a location 132 and may refer to an action performed by the user at the location 132. As a very specific non-limiting example, the note could correspond to a note that the user 104 has just started a fresh coffee brew or that a particular location has just been cleaned or the location has a mess and requires cleaning.

The note may be stored in the message database 212 by the server 208 for later delivery to another user (step 908). The method then continues when the server 208 determines that another user is within proximity of the predetermined location or otherwise possess an interest in the predetermined location (step 912). This determination may be made based on information obtained from a content of the note or based on other users 104 having a path 316 that intersects the predetermined location.

In response to the determination of step 912, the method continues with the server 208 obtaining the note message from the database 212 (step 916) and then delivering the note to the other user 104 (step 920). In some embodiments, the mechanism by which the message is delivered to the other user 104 may depend upon the nature and content of the note and/or the communication capabilities of the communication device 108 carried by the user 104.

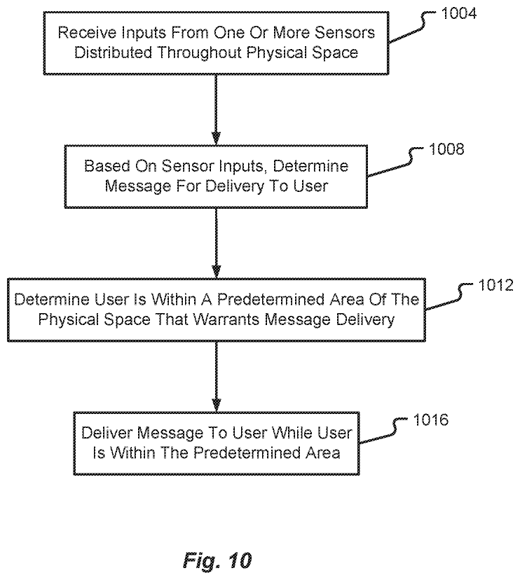

With reference now to FIG. 10, a fifth messaging method will be described in accordance with at least some embodiments of the present disclosure. The method begins with the server 208 receiving inputs or sensor information from one or more sensors 128 distributed through the physical space (step 1004). The sensor information may include readings obtained by the sensors and/or status information for the sensor (e.g., whether the sensor 128 are still operating properly, a battery status of the sensor 128, etc.). The information received from the various sensors 128 may be stored in the sensor information database 118 and may be continuously monitored by the system management instruction set 240 to determine if any conditions of the system require user attention.

The method continues with the server 208 determining that a message should be generated and delivered to a user (step 1008). This determination may be made based on the sensor inputs and, in some embodiments, may also depend upon notes received from various users 104 that are moving throughout the physical space.

The server 208 then refers to the user behavior database 216 to identify a user 104 that is positioned within a nearest proximity of an area that is related to the sensor inputs that warranted message delivery (step 1012). For instance, the server 208 may determine, based on the sensor inputs, that an object 112 requires attention. Rather than preparing and sending a broadcast to all users 104, which would be disruptive and unnecessarily consume computing resources, the server 208 may identify a particular user 104 to receive the message. The identification of the user 104 may depend upon user proximity with the object and/or user role within the system. In some embodiments, the determined message is delivered to the particular user 104 that was previously identified (step 1016). In some embodiments, the server 208 will attempt to deliver the message to the identified user 104 while the user 104 is within the predetermined area that is related to the sensor inputs. If the user 104 leaves the predetermined area prior to receiving the message, then the serve 208 may attempt to identify a new user 104 as a target for the message. In some embodiments, the message may be delivered to the communication device 108 of the user 104 or the message may be provided by a stationary message delivery mechanism (e.g., a POS system, a speaker, a buzzer, etc.) that is positioned in or near the predetermined area.

Additional non-limiting examples of the various types and variants of messaging methods will now be described in accordance with at least some embodiments of the present disclosure.

### EXAMPLE 5

AUDIO/VIDEO/TEXT content can be sent directly to each or all persons in a local area of via a wireless content transmission system to each communication device 108. This may be broadcast by the message management server 208 via the location management through a simple broadcast system. As an example, the manager of a store sends a verbal message live through a microphone and audio transmission system to one or all end users within that location. The message could be related to an emergency, special offer, customer announcement, etc. End users do not have to tap their wearable communication device to get the message. Rather, the message is forced to load and play.

### EXAMPLE 6

When an end user 104 wearing their wearable communication device 108 comes into the operating range of an object 112 or location 132 that has a tag 116 affixed to it, the end user has the option to tap on a button that is attached to their wearable communication device 108 to trigger the playing of the content associated with that location and or object they are standing near. More specifically, an end user 104 is standing by an object 112 used in their job. The end user 104 requires some assistance on the operation of the object, but there is no one available to help. User 104 taps a button on their wearable communication device 108 and this triggers the playing of content specific to that object 112. The content may walk the end user 104 through the steps of the object operation or provides a safety message or any other messaging needed to be communicated about that location 132 and or object 112. The end user can repeat the information playback by tapping the button again and again.

### EXAMPLE 7

When an end user 104 wearing their wearable communication device 108 comes into the operating range of a specially configured tag 116 affixed to the object 132 and or location 112, the message management server 208 is automatically triggered to deliver special messaging content to that end user's 104 wearable communication device 108. The system will automatically deliver this special messaging to the end user 104 and play the information whether the end user taps a button on their wearable communication device 108 or not. As an example, the end user 104 enters the rest room wearing his/her wearable communication device 108. The restroom has its own tag 116 which triggers the message management server 208 to deliver the audio content to the end user's wearable communication device 108 reminding the end user to “WASH THEIR HANDS for 20 seconds before leaving the bathroom”. It may play the information one or more times automatically as pre-defined by the end user's employer.

### EXAMPLE 8

End user triggers a special EMERGENCY BUTTON on their wearable communication device 108 and automatic emergency information is played to provide information on whom and how to contact the appropriate people to respond. It also could dial 9-1-1 automatically and or the end user's location manager. Specifically, but in a non-limiting example, the end user 104 encounters an emergency requiring immediate medical or emergency assistance. The end user 104 pushes a special EMERGENCY BUTTON on their wearable communication device 108 and the message management server 208 delivers content to the end user's 104 communication device 108 on what to do and how to proceed with responding to the emergency. The wearable communication device 108 could also trigger the message management server 208 to dial 9-1-1 and/or send a signal to the location manager that there is an emergency located in proximity with the user's 104 wearable communication device 108.

### EXAMPLE 9

End user encounters an issue needing corrective action. Unless it is an emergency or very urgent issue, end user is unlikely to stop their work to go find a manager. The opportunity for timely corrective action is potentially lost and risk for company increases. The end user 104 may be enabled to tap a button on their wearable communication device 108 to record a note. The note is transmitted back to the server and stored in the message database 212 for later delivery to the other user, along with the end user profile info and location information. The message management server 208 converts the message to text and displays it on manger's dashboard as an item that needs resolution.

### EXAMPLE 10

The end user has a choice of “buttons” on their wearable communication device 108 and selects what content to be delivered to them at that specific time. The button could be a digital button on a touch screen or a mechanical button. There may be hundreds of digital buttons available to select from with each associated with a different object 112 and or location 132. As a specific, but non-limiting example, an end user 104 is standing by a new oven used in his job.

The end user 104 requires some assistance on the operation procedures or safety precautions of the new oven but there is no one available to help. End user 104 taps the button that has an icon that designates an oven and the type of information they are looking for. Depressing the oven button on the wearable communication device 108 triggers the playing of content specific to that oven. The content now walks the end user through the steps of the oven's operation and or safety message or any other messaging needed to be communicated about that location 132 and or object 112. The end user 104 can repeat the information playback by tapping the button again and again.

### EXAMPLE 11

The message management server 208 monitors environments and processes and should any of those fall outside of a pre-determined specified normal, the message management server 208 will contact an individual associated with that environment/process and automatically advise them of the issue. That end user 104 could then take the necessary steps to resolve or at least minimize any disruption the issue could result in and the associated expenses the issue could have caused. As a specific, but non-limiting example, a shipment of frozen fish is shipping to fish restaurant via a trucking company. The fish is designated to stay at 40F or below. The trucker hauling the fish does not know that his refrigeration system has been down for a number of hours. When he arrives at his delivery point he drops the fish off and no one know, at times, that the fish is now potentially a hazard to eat.

Embodiments of the present disclosure can solve the above problem by providing a tag and sensor combination inside the shipment that communicates to the end user 104 (e.g. dispatcher, logistics managers) wearing a wearable communication device 108 advising them the refrigeration unit in the truck is off and the associated temperature is increasing to hazardous levels. The end user 104 can now take action, for example by: warning the trucking company and or trucker to check the truck's refrigeration units and if it can be simply put on, he does so; or if the shipment of fish will not make it to its delivery point in safe and edible condition then the end user can schedule another truck to deliver a new shipment of fish so the fish restaurant does not have a disruption in service of fish to their customers.

Specific details were given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

What is claimed is:

1. A system, comprising:
a plurality of tags, each tag from the plurality of tags being associated with an object or location;
a network interface configured to receive information from the plurality of tags and further configured to exchange messages with communication devices that are associated with users;
a processor coupled with the network interface; and
computer memory coupled with the processor, wherein the computer memory includes processor-executable instructions that comprise:
a system management instruction set configured to determine a status of the object or location based on the information received from the plurality of tags; and
a message delivery instruction set configured to determine that a user is positioned within proximity of a particular object or location, identify a message to deliver to the user based on a unique user/object or location pair established between the user and the particular object or location, determine a communication capability of a communication device associated with the user, and based on the unique user/object or location pair and further based on the communication capability of the communication device, deliver the identified message to the communication device while the user is positioned within proximity of the particular object or location.

2. The system of claim 1, wherein the message delivery instruction set is further configured to determine a content of the message based on a condition of the particular object or location.

3. The system of claim 2, wherein the condition of the particular object or location is determined based on sensor information received from a sensor that is associated with the particular object or location and that converts a physical property around the object or location into an electronic signal.

4. The system of claim 2, wherein the condition of the particular object or location is determined based on a note received from a different user that was previously within proximity of the particular object or location and wherein the note is stored in a message database and further referenced by the message delivery instruction set in response to determining that the user is positioned within proximity of the particular object or location.

5. The system of claim 1, wherein the communication device comprises a wearable communication device that is uniquely associated with the user and wherein the identified message is delivered to the wearable communication device via a wireless communication protocol.

6. The system of claim 1, wherein the instructions further comprise:
a user behavior instruction set configured to monitor user behavior activity of the users and determine a normal behavior model for at least one user relative to the plurality of tags.

7. The system of claim 6, wherein the user behavior instruction set is further configured to determine, on a per-user basis, normal behavior models for the users relative to the plurality of tags and wherein the message delivery instruction set is configured to identify the message to deliver to the user based on a reference to a normal behavior model for the user.

8. The system of claim 6, wherein the normal behavior model is updated in response to determining that a new normal behavior exists for the at least one user relative to the plurality of tags.

9. The system of claim 1, wherein the information received from the plurality of tags at the network interface is received via a communication network and via the communication devices that are associated with the users.

10. The system of claim 9, wherein the plurality of tags are configured to pair with the communication devices and exchange information with the communication devices via a proximity-based communication protocol.

11. The system of claim 10, wherein the information exchanged between the plurality of tags and the communication devices comprises a tag URL stored in memory of the tag and wherein the tag URL comprises a reference to an identifier of the associated object or location.

12. The system of claim 10, wherein the information exchanged between the plurality of tags and the communication devices comprises sensor information received from a sensor that is associated with one of the plurality of tags.

13. A method, comprising:
receiving, at a network interface, information from a plurality of tags;
exchanging, via the network interface, messages with communication devices that are associated with users;
determining, with a processor, a status of a particular object or location based on the information received from the plurality of tags;
determining, with a processor, that a user is positioned within proximity of the particular object or location based on the messages exchanged with the communication devices;
identifying, with a processor, a message to deliver to the user based on a unique user/object or location pair established between the user and the particular object or location;
determining, with a processor, a communication capability of a communication device associated with the user; and
based on the unique user/object or location pair and further based on the communication capability of the communication device, delivering, via the network interface, the identified message to the communication device while the user is positioned within proximity of the particular object or location.

14. The method of claim 13, further comprising:
determining, with the processor, a content of the message based on a condition of the particular object or location, wherein the condition of the particular object or location is determined based on sensor information received from a sensor that is associated with the particular object or location and that converts a physical property around the object or location into an electronic signal.

15. The method of claim 14, wherein the condition of the particular object or location is further determined based on a note received from a different user that was previously within proximity of the particular object or location and wherein the note is stored in a message database and further referenced by the message delivery instruction set in response to determining that the user is positioned within proximity of the particular object or location.

16. The method of claim 14, further comprising:
monitoring, with the processor, user behavior activity of the users; and
determining, with the processor, a normal behavior model for at least one user relative to the plurality of tags.

17. The method of claim 16, further comprising:
determining, on a per-user basis and with the processor, normal behavior models for the users relative to the plurality of tags and wherein the message delivery instruction set is configured to identify the message to deliver to the user based on a reference to a normal behavior model for the user; and
updating, with the processor, the normal behavior model in response to determining that a new normal behavior exists for the at least one user relative to the plurality of tags.

18. The method of claim 13, wherein the information received from the plurality of tags at the network interface is received via a communication network and via the communication devices that are associated with the users.

19. The method of claim 18, wherein the plurality of tags are configured to pair with the communication devices and exchange information with the communication devices via a proximity-based communication protocol.

20. The method of claim 19, wherein the information exchanged between the plurality of tags and the communication devices comprises a tag URL stored in memory of the tag and wherein the tag URL comprises a reference to an identifier of the associated object or location.
